(19) United States
(12) Patent Application Publication
(10) Pub. No.: US 2020/0368885 A1
(43) Pub. Date: Nov. 26, 2020

(54) FASTENING SOCKET

(71) Applicant: Wuxi Universal Network Corporation Co.,Ltd, Wuxi (CN)

(72) Inventors: Sheng-Cheng SHEN, Wuxi (CN); Qing CHEN, Wuxi (CN); Zheng-Wei SONG, Wuxi (CN)

(21) Appl. No.: 16/419,948

(22) Filed: May 22, 2019

(51) Int. Cl. B25B 23/142; B25B 13/06

(52) U.S. Cl. CPC B25B 23/1422; B25B 13/06

(57) ABSTRACT

A fastening socket includes a socket main body having a first insertion hole formed thereon, the first insertion hole configured to match with a plug; a securement base installed inside the socket main body and having a second insertion hole formed thereon; the second insertion hole configured to match with the first insertion hole; an insertion bracket secured inside the securement base and configured to match with the second insertion hole; a fastening seat rotatably installed on the securement base and having a side surface formed with a fastening surface; the fastening surface configured to press the insertion bracket onto the plug firmly; and a rotational handle secured onto the fastening seat and configured to locate at a surface of the socket main body. Accordingly, the fastening socket of the present invention is of simple structure that is facilitated for use with reliable fastening and prolonged useful lifetime.

### BACKGROUND OF THE INVENTION

### Field of the Invention

The technical field relates to a socket, in particular, to a fastening socket.

### Description of Related Art

It has been found that plugs inserted into conventional socket are prone to disengage therefrom under external forces applied thereon. To prevent the disengagement of the plugs, a fastening device is further installed. Nevertheless, the currently existing fastening devices are of complicated structures, such that the manufacturing costs thereof are high.

### SUMMARY OF THE INVENTION

To overcome the aforementioned drawback, the present invention provides a fastening socket of simple structure and low manufacturing cost.

In an exemplary embodiment of the present invention, a fastening socket comprises a socket main body having a first insertion hole formed thereon, the first insertion hole configured to match with a plug; a securement base installed inside the socket main body, and having a second insertion hole formed thereon; the second insertion hole configured to match with the first insertion hole; an insertion bracket secured inside the securement base and configured to match with the second insertion hole; a fastening seat rotatably installed on the securement base and having a side surface formed with a fastening surface; the fastening surface configured to press the insertion bracket onto the plug firmly; and a rotational handle secured onto the fastening seat and configured to locate at a surface of the socket main body.

Through the use of the aforementioned exemplary technical solution, after inserting the plug and rotating the rotational handle, the rotational handle drives the fastening seat to rotate, and the fastening surface of the fastening seat presses the insertion bracket firmly onto the plug. Accordingly, it is able to achieve the fastening of plug in order to prevent the plug from disengagement with the socket under the effect of external force applied thereon.

The fastening of plug is achieved by rotating the fastening seat, such that a device of simple structure, facilitated use and low manufacturing cost is provided.

Preferably, the fastening surface of the fastening seat comprises a fastening protrusion, and the fastening protrusion is configured to press onto the insertion bracket firmly.

Preferably, the side surface of the fastening seat further comprises a restricting surface, and the restricting surface is used to restrict a rotational position of the fastening seat.

With the use of the aforementioned exemplary technical solution, the restricting surface is able to restrict the rotational position of the rotational handle in order to allow the rotational handle to correspond with the position label marked on the surface of the socket main body.

Preferably, the insertion bracket comprises an insertion bracket seat secured onto the securement base; a fixed clamp arranged at one end of the insertion bracket seat; a movable clamp arranged at one end of the insertion bracket seat, the fixed clamp and movable clamp arranged opposite from each other, and the movable clamp arranged at one side of the fastening surface.

Through the use of the aforementioned exemplary technical solution, the plug is inserted between fixed clamp and the moveable clamp such that it is able to ensure a reliable contact of the plug.

Preferably, the moveable clamp comprises two clamps, and a gap is formed between the two moveable clamps.

Through the use of the aforementioned exemplary technical solution, the two moveable clamps press firmly onto the plug respectively, and the two moveable clamps are able to ensure the firm press onto the plug in comparison to the use of only one movable clamp; therefore, it is able to prevent the failure of the moveable clamp in achieving a firm press onto the plug.

Preferably, an outer side surface of the moveable clamp and the fixed clamp respectively comprises a reinforced protrusion having an elongated shape; the reinforced protrusion is arranged along a length direction of the moveable clamp and the fixed clamp.

Through the use of the aforementioned exemplary technical solution, the reinforced protrusion is able to increase the strength of the moveable clamp and the fixed clamp in order to prevent any permanent bending of the movable clamp and the fixed clamp that may cause failure in the fastening of the plug.

Preferably, the fastening seat is made of a Polycarbonate and glass fiber material.

Through the use of the aforementioned exemplary technical solution, a Polycarbonate and glass fiber mixed material is able to effectively ensure the strength and wear resistance of the device in order to prolong its useful lifetime.

Preferably, the device further comprises a sealing ring secured inside a sealing slot of the fastening seat.

Through the use of the aforementioned exemplary technical solution, the sealing ring is able to prevent water from entering the internal of the fastening socket.

Preferably, the socket main body comprises removal auxiliary rods arranged at a rear end of the socket and located at two sides of the socket respectively.

Through the use of the aforementioned exemplary technical solution, the removal auxiliary rods are able to facilitate the gripping to remove the plug from the socket.

Preferably, the socket main body comprises three first insertion holes arranged in a delta shape, a rear portion of each of two sides of the first insertion holes comprises an arched slot corresponding to the removal auxiliary rod.

Through the use of the aforementioned exemplary technical solution, the multiple number of insertion holes increases the utilization rate of the socket and facilitates the use thereof.

In comparison to the existing technology, the present invention has the following beneficial effects.

The present invention provides a fastening socket that is of simple structure, facilitated use, reliable fastening and prolonged useful lifetime.

### BRIEF DESCRIPTION OF DRAWING

FIG. 1 is a top axonometric structure drawing of the fastening socket of the present invention;

FIG. 2 is a bottom axonometric structure drawing of the fastening socket of the present invention;

FIG. 3 is an illustration showing the configuration of the securement base, fastening seat and insertion bracket of the present invention;

FIG. 4 is a front view of the configuration of the securement base, fastening seat and insertion bracket of the present invention;

FIG. 5 is an illustration showing the structure of the securement base of the present invention;

FIG. 6 is an illustration showing the structure of the fastening seat and insertion bracket of the present invention;

FIG. 7 is an illustration showing the structure of the fastening seat of the present invention;

FIG. 8 is a top axonometric structure drawing of the insertion bracket of the present invention; and

FIG. 9 is a bottom axonometric structure drawing of the insertion bracket of the present invention.

### DETAILED DESCRIPTION OF THE INVENTION

The following provides a detailed technical content of the present invention along with the accompanied drawings.

Through the rotation of a fastening seat 3, the present invention is able to provide a fastening socket that is able to press a plug firmly with simple structure, facilitated use and low manufacturing cost.

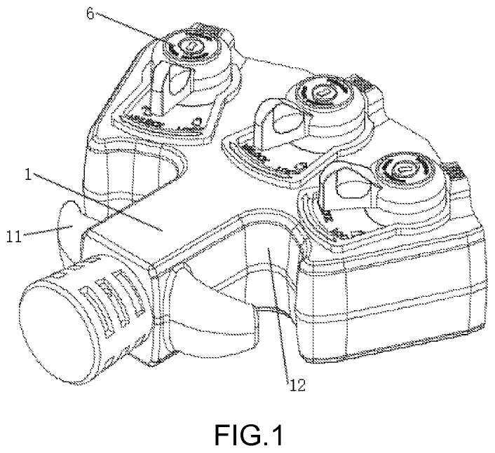

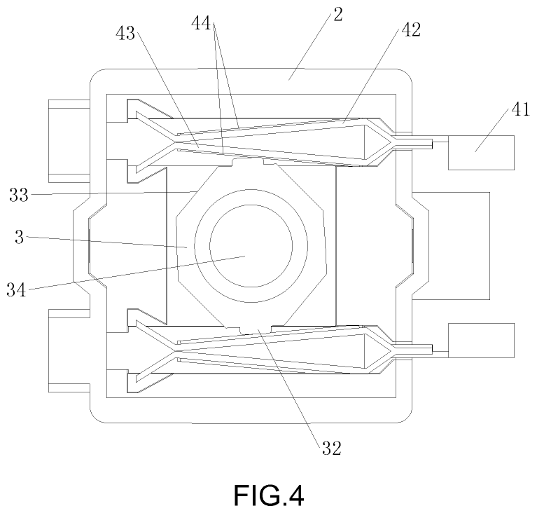

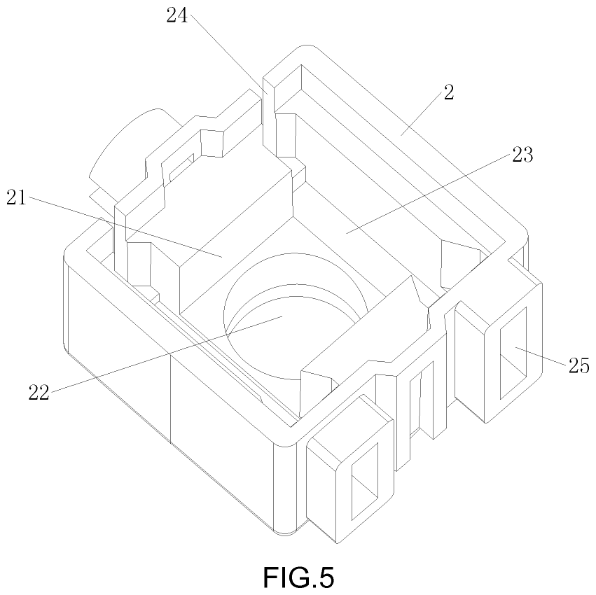

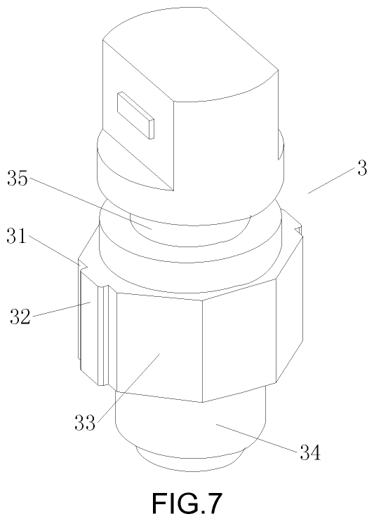

Please refer to FIG. 1 to FIG. 9. A fastening socket comprises a socket main body 1. The socket main body 1 comprises a first insertion hole 13. The first insertion hole 13 matches with a plug. It further comprises a securement base 2. The securement base 2 is installed inside the socket main body 1. The securement base 2 comprises a second insertion hole 25, and the second insertion hole 25 matches with the first insertion hole 13. It also comprises an insertion bracket 4. The insertion bracket 4 is secured inside the securement base 2, and the insertion bracket 4 matches with the second insertion hole 25. It further comprises a fastening seat 3. The fastening seat 3 is rotatably installed on the securement base 2. A side surface of the fastening seat 3 comprises a fastening surface 31, and the fastening surface 31 is used for pressing the insertion bracket 4 onto the plug firmly. In addition, it further comprises a rotational handle 6. The rotational handle 6 is secured onto the fastening seat 3, and the rotational seat 6 is located at a surface of the socket main body 1.

After the plug is inserted into the socket, the rotational handle 6 is rotated, and the rotational handle 6 then drives the fastening seat 3 to rotate. The fastening surface 31 of the fastening seat 3 is able to press the insertion bracket 4 onto the plug firmly in order to achieve the fastening of the plug, thereby preventing the plug from disengagement under the effect of external force applied thereon.

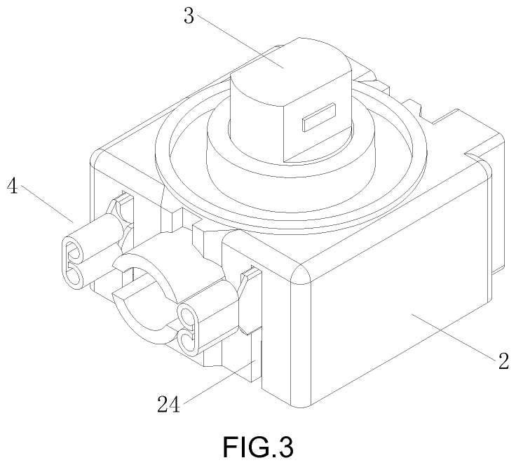

Specifically, as shown in FIG. 3 to FIG. 5, the securement base 2 includes a rotating slot 21. The rotating slot 21 is located at a center position of the securement base 2. The fastening seat 3 is located inside the rotating slot 21. A bottom portion of the rotating slot 21 includes a rotating hole 22 formed thereon. The fastening seat 3 is rotatably installed inside the rotating hole 22. The internal of the securement base 2 further includes an insertion bracket slot 23. The insertion bracket slot 23 is used for receiving the insertion bracket 4. One end of the insertion bracket slot 23 is connected to the securement slot 24, and another end thereof is connected to the second insertion hole 25. The securement slot 24 is used for securing the insertion bracket 4. The securement slot 24 and the second insertion hole 25 are located at two ends of the securement base 2 respectively.

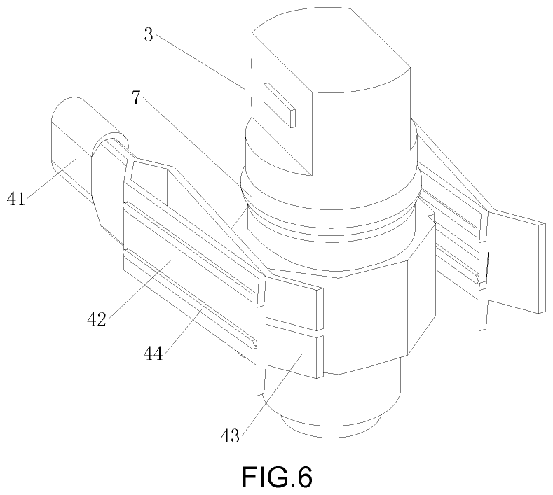

As shown in FIG. 6, the fastening surface 31 of the fastening seat 3 comprises a fastening protrusion 32 formed thereon, and the fastening protrusion 32 is used for pressing onto the insertion bracket 4 firmly.

A side surface of the fastening seat 3 further comprises a restricting surface 33. The restricting surface 33 is used for restricting a rotational position of the fastening seat 3. When the fastening seat 3 rotates inside the rotating slot 21 of the securement base 2, the restricting surface 33 and the side surface of the rotating slot 21 are able to contact with each other to stop the rotation in order to restrict the rotational position of the rotational handle 6, thereby allowing the rotational handle 6 to correspond to the position label marked on the surface of the socket main body 1.

A bottom of the fastening seat 3 comprises a rotating axle 34. The rotating axle 34 is rotatably installed inside the socket main body 1.

The fastening seat 3 further comprises a sealing slot 35. The sealing slot 35 includes a sealing ring 7 installed at an internal thereof, and the sealing ring 7 is located inside the rotating hole 22. The sealing ring 7 is able to prevent water from entering the internal of the fastening socket in order to protect the socket and occurrence of short-circuit.

The fastening seat 3 is made of Polycarbonate and glass fiber material. A Polycarbonate and glass fiber mixed material is able to effectively ensure the strength and wear resistance of the device as well as to prolong its useful lifetime.

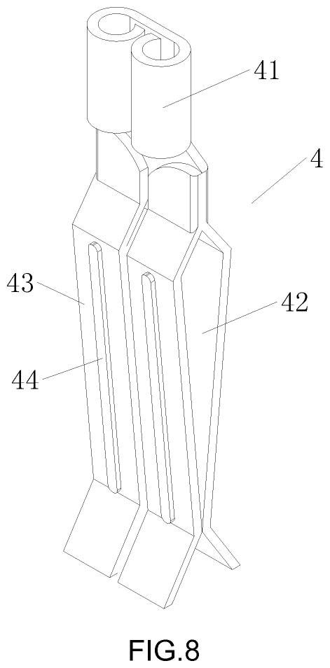

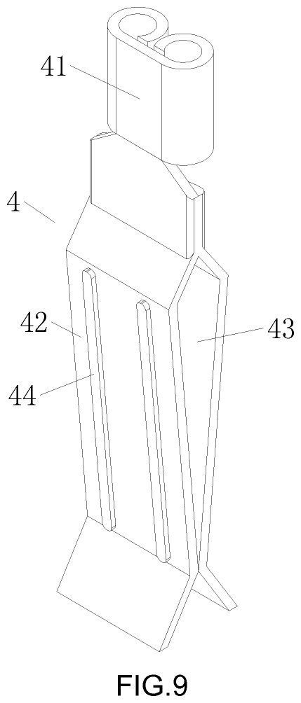

As shown in FIG. 8 and FIG. 9, the insertion bracket 4 comprises an insertion bracket seat 41. The insertion bracket seat 41 is secured inside the securement slot 24 of the securement base 2. It further comprises a fixed clamp 42, and the fixed clamp 42 is located at one end of the insertion bracket seat 41. It further comprises a moveable clamp 43, and the moveable clamp 43 is located at one end of the insertion bracket set 41. The fixed clamp 42 and the moveable clamp 43 are arranged opposite from each other, and the moveable clamp 43 is located at one end of the fastening surface 31.

The plug is inserted between the fixed clamp 42 and the moveable clamp 43 in order to effectively ensure a reliable contact with the socket.

The moveable clamp 43 can be configured to include two clamps, and a gap is formed between the two moveable clamps 43.

The two moveable clamps 43 respectively press onto the plug firmly. The use of two moveable clamps 43 is able to effectively ensure the firm press onto the plug in comparison to only one moveable clamp 43 only, such that it is able to prevent the moveable clamps 43 from failing to press onto the plug firmly.

An outer side of the moveable clamp 43 and the fixed clamp 42 comprises a reinforced protrusion 44 having an elongated shape formed thereon respectively. The reinforced protrusion 44 is arranged along a length direction of the moveable clamp 43 and the fixed clamp 42.

The reinforced protrusion 44 is able to increase the strength of the moveable clamp 43 and the fixed clamp 42 in order to prevent any permeable bending of the moveable clamp 43 and the fixed clamp 42 that may cause failure in the fastening of the plug.

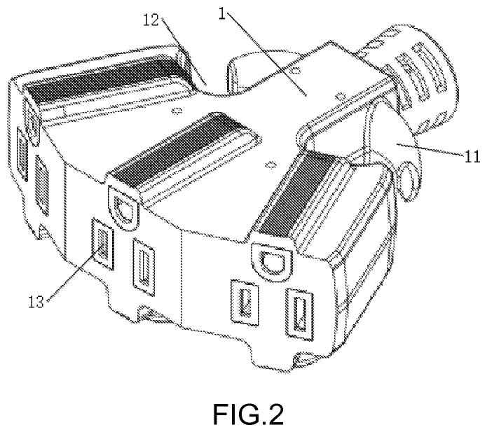

As shown in FIG. 1 and FIG. 2, the socket main body 1 further comprises removal auxiliary rods 11. The removal auxiliary rods 11 are arranged at the rear end of the socket and located at two sides of the socket respectively. The removal auxiliary rods 11 are provided to facilitate the removal of the plug from the socket main body 1.

The socket main body 1 comprises three first insertion holes 13, and the first insertion holes are arranged in a delta shape. A rear portion of two sides of the first insertion holes 13 respectively comprises an arched slot 12, and the arched slots 12 are formed to correspond with the removal auxiliary rods 11. The arched slots 12 are provided to facilitate the gripping of the socket main body 1 during the insertion of the plug. The multiple number of insertion holes increases the utilization rate of the socket and facilitates the use thereof.

What is claimed is:

1. A fastening socket, comprising:
a socket main body having a first insertion hole formed thereon, the first insertion hole configured to match with a plug;
a securement base installed inside the socket main body and having a second insertion hole formed thereon; the second insertion hole configured to match with the first insertion hole;
an insertion bracket secured inside the securement base and configured to match with the second insertion hole;
a fastening seat rotatably installed on the securement base and having a side surface formed with a fastening surface; the fastening surface configured to press the insertion bracket onto the plug firmly;
a rotational handle secured onto the fastening seat and configured to locate at a surface of the socket main body; and
wherein after inserting the plug and rotating the rotational handle, the rotational handle drives the fastening seat to rotate, and the fastening surface of the fastening seat presses the insertion bracket firmly onto the plug.

2. The fastening socket according to claim 1, wherein the fastening surface of the fastening seat comprises a fastening protrusion, and the fastening protrusion is configured to press onto the insertion bracket firmly.

3. The fastening socket according to claim 1, wherein the side surface of the fastening seat further comprises a restricting surface, and the restricting surface is used to restrict a rotational position of the fastening seat.

4. The fastening socket according to claim 1, wherein the insertion bracket comprises:
an insertion bracket seat secured onto the securement base;
a fixed clamp arranged at one end of the insertion bracket seat;
a movable clamp arranged at one end of the insertion bracket seat, the fixed clamp and movable clamp arranged opposite from each other, and the movable clamp arranged at one side of the fastening surface.

5. The fastening socket according to claim 4, wherein the moveable clamp comprises two clamps, and a gap is formed between the two moveable clamps.

6. The fastening socket according to claim 5, wherein an outer side surface of the moveable clamp and the fixed clamp respectively comprises a reinforced protrusion having an elongated shape; the reinforced protrusion is arranged along a length direction of the moveable clamp and the fixed clamp.

7. The fastening socket according to claim 4, wherein an outer side surface of the moveable clamp and the fixed clamp respectively comprises a reinforced protrusion having an elongated shape; the reinforced protrusion is arranged along a length of the moveable clamp and the fixed clamp

8. The fastening socket according to claim 1, wherein the fastening seat is made of a Polycarbonate and glass fiber material.

9. The fastening socket according to claim 1, further comprising a sealing ring secured inside a sealing slot of the fastening seat.

10. The fastening socket according to claim 1, wherein the socket main body comprises removal auxiliary rods arranged at a rear end of the socket and located at two sides of the socket respectively.

11. The fastening socket according to claim 10, wherein the socket main body comprises three first insertion holes arranged in a delta shape, a rear portion of two sides of the first insertion holes respectively comprises an arched slot corresponding to the removal auxiliary rods.
